(19) United States
(12) Patent Application Publication
(10) Pub. No.: US 2013/0240349 A1
(43) Pub. Date: Sep. 19, 2013

(54) EFFICIENT SYSTEM FOR PHOTOGENERATION OF REDOX MEDIATOR RADICALS AND THEIR USE FOR SOLAR-TO-FUEL CONVERSION

(71) Applicant: EMORY UNIVERSITY, Atlanta, GA (US)

(72) Inventors: Tianquan Lian, Tucker, GA (US); Haiming Zhu, Atlanta, GA (US)

(73) Assignee: Emory University, Atlanta, GA (US)

(21) Appl. No.: 13/795,142

(22) Filed: Mar. 12, 2013

Related U.S. Application Data
(60) Provisional application No. 61/610,035, filed on Mar. 13, 2012.

(51) Int. Cl. B01J 19/08

(52) U.S. Cl. CPC B01J 19/08
USPC 204/157.52; 252/301.36

(57) ABSTRACT

This disclosure relates to compositions of nanoparticles and methods of their use related thereto such as for solar-to-fuel conversion. In general, the compositions include specific nanostructures that act as photosensitizers can help provide near quantum yield for light driven redox mediator reduction and hydrogen generation. In the presence of a catalyst and redox mediator, compositions described herein can efficiently convert sunlight to hydrogen, providing a versatile approach to solar-to-fuel conversion.

### CROSS-REFERENCE TO RELATED APPLICATIONS

This application claims priority to U.S. Provisional Application No. 61/610,035, filed Mar. 13, 2012 and incorporated herein in its entirety.

### FIELD

The disclosure is in the field of alternative energy, specifically solar-to-fuel, generation.

### BACKGROUND

Producing renewable clean energy is one of the most profound challenges of the 21^{st} century. A major area of research into clean energy is focused on the development of light harvesting, water based fuel producing systems. Direct solar-to-fuel conversion has been intensely investigated in recent years as a potential approach for solar energy conversion and storage. Despite intense global efforts to create such systems, no existing systems are efficient enough to provide fuel from light.

The advancement of direct solar-to-fuel conversion technologies requires the development of efficient catalysts as well as efficient materials and novel approaches for light harvesting and charge separation. As a typical solar-to-fuel transformation reaction involves i) the absorption of light by the sensitizer, ii) the charge separation and reduction of the catalyst via direct electron transfer or redox mediators, and iii) the turnover of the substrates to fuel by the reduced catalyst. The efficiencies of these processes determine the overall external quantum efficiency of solar-to-fuel conversion. Therefore, the advancement of solar-to-fuel conversion technologies requires the development of efficient catalysts for H₂ evolution and CO₂ fixation as well as better materials and approaches for light harvesting and charge separation.

Methods have been suggested for to increase efficiency of photosensitizers. For example, Herbst reported a process for producing hydrogen from water using light energy and aqueous compositions (WO 1981/002851). De Jong, et al reported a method and apparatus for photocatalytic water splitting (EP 2407419 A1). Proteins and small molecules have been explored extensively as photosensitizers although the quantum efficiency of these materials has proven insufficient. Peters, et al reported composite nanomaterials for photocatalytic hydrogen production and methods of their use (WO 2007/086918).

For solar-to-fuel technology to be viable, the efficiency of light-harvesting and charge separation must be increased dramatically. Kim, et al reported semiconductor nanocrystal heterostructures having specific charge carrier confinement (U.S. Pat. No. 7,390,568). Kim, et al reported devices comprising coated semiconductor nanocrystals heterostructures (U.S. Pat. No. 7,825,405). Carbone et al reported the synthesis and micrometer-scale assembly of colloidal CdSe/CdS Nanorods (Nano Lett, 2007, 7(10), 2942-50). Talapin, et al reported the seeded growth of highly luminescent CdSe/CdS nanoheterostructures with rod and tetrapod morphologies (Nano Lett, 2007, 7(10), 2951-9).

None of the existing methods of materials provide sufficient light harvesting and charge separation to allow use in providing alternative energy systems.

### SUMMARY

This disclosure relates to systems and compositions of photosensitizers and related uses thereof for solar-to-fuel conversion. In general, the system includes certain dot-in-rod nanoheterostructures that can convert solar energy into hydrogen more effectively than existing systems. In certain embodiments, the disclosure contemplates compositions and systems including at least a redox mediator, an electron donor and a semiconducting nanoheterostructure photosensitizer.

In certain embodiments, the redox mediator is methyl viologen.

In certain embodiments, the electron donor is mercaptopripionic acid.

In certain embodiments, the semiconducting nanostructure photosensitizer comprises:
a) a core nanocrystal including a first semiconductor material; and
b) an overcoating including a second semiconductor material on the core nanocrystal.

In certain embodiments, the first semiconductor material is a Group II-VI compound, a Group II-V compound, a Group III-VI compound, a Group III-V compound, a Group IV-VI compound, a Group I-III-VI compound, a Group II-IV-VI compound, or a Group II-IV-V compound. In certain specific embodiments, the first semiconductor material is selected from ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TlN, TlP, TlAs, TlSb, PbS, PbSe, PbTe, or mixtures thereof. In more particular embodiments, the first semiconductor material is CdSe.

In certain embodiments, the second semiconductor material is a Group II-VI compound, a Group II-V compound, a Group III-VI compound, a Group III-V compound, a Group IV-VI compound, a Group I-III-VI compound, a Group II-IV-VI compound, or a Group II-IV-V compound. In certain embodiments, the second semiconductor material is selected from ZnO, ZnS, ZnSe, ZnTe, CdO, CdS, CdSe, CdTe, MgO, MgS, MgSe, MgTe, HgO, HgS, HgSe, HgTe, AlN, AlP, AlAs, AlSb, GaN, GaP, GaAs, GaSb, InN, InP, InAs, InSb, TlN, TlP, TIAs, TlSb, TlSb, PbS, PbSe, PbTe, or mixtures thereof. In more particular embodiments, the second semiconductor material is CdS.

In certain embodiments, the disclosure relates to compositions comprising:
a) a core nanocrystal including a first semiconductor material; and
b) an overcoating including a second semiconductor material on the core nanocrystal, wherein the first semiconductor material is CdSe and the second semiconductor material is CdS; and additionally including a redox mediator wherein the redox mediator is methyl viologen; and
   a) the electron donor is mercaptoproprionic acid.

Certain embodiments relate to methods for photoreduction of a redox mediator comprising exposing compositions as described herein to light. In certain embodiments, methods of use of the compositions are provided in which the efficiency (quantum yield) is greater than 87%, or greater than 90%, or greater than 95%, or greater than 98%.

In certain embodiments, the system further includes a platinum nanoparticle.

In certain embodiments, the disclosure contemplates a method for fuel production comprising combining a composition as described herein with a fuel source and a catalyst, and exposing the mixture to light. In certain embodiments, the disclosure contemplates the fuel source is water or carbon dioxide. In certain embodiments, the disclosure contemplates the catalyst is nanoparticles of platinum or palladium. In certain embodiments, the catalyst is an enzyme, such as hydrogenase or formate dehydrogenase. In certain embodiments, the fuel source is water and the catalyst is platinum nanoparticles.

### BRIEF DESCRIPTION OF THE FIGURES

FIG. 1 (A) is a schematic depiction of relevant processes in a solar-to-fuel conversion system containing sacrificial electron donors (SDs), sensitizer, redox mediators (MV²⁺) and catalysts; (B) is a schematic structures (left) and TEM images (right) of CdSe/CdS dot-in-rod (DIR) NRs as well as CdS rods of similar dimensions, CdSe/CdS core/shell QDs of similar lowest exciton energy (CS-SE), and CdSe/CdS core/shell QDs of similar volume (CS-SV) as the DIR. The horizontal lines in the schematic structures indicate the extent of delocalization of the lowest energy conduction band electron and valence band hole; and (C) shows extinction coefficient spectra of CdSe/CdS DIR, CdSe seed, CdS rod, CdSe/CdS CS-SE, CdSe/CdS CS-SV and Ru(bipy)₃²⁺.

FIG. 2 shows the size (length and diameter for some prepared nanorods and diameter for some prepared quantum dots) distribution for (A) CdSe/CdS DIR, (B) CdS NR, (C) CdSe/CdS CS-SV (D) CdSe/CdS CS-SE.

FIG. 3 3A shows graphs of steady-state photoreduction of MV²⁺. “DIR” bar indicates that approx. one MV radical is produced for each photon that strikes the DIR.

FIG. 3B shows a graphic representation of the reaction of the DIR in the presence of a fuel source and catalyst, and a graphic representation showing quantum yiled in relation to the shapes of different quantum dots, spheres, nanorods and DIR configurations.

FIG. 4 shows the amount of H₂ produced in a model system using excess MPA as the electron donor in a phosphate buffer solution containing different light sensitizers. Continued H₂ production over 24 hrs of illumination (inset) shows that DIR sensitizers are stable.

FIG. 5 shows emissions spectra of the CdSe seed, CdS nanorods, CdSe/CdS CS-SE, CdSe/CdS CS-SV and CdSe/CdS dot-in-rods.

### DETAILED DISCUSSION

### Definitions

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

Embodiments of the present disclosure will employ, unless otherwise indicated, techniques of nanotechnology, organic chemistry, biochemistry, molecular biology, pharmacology, and the like, which are within the skill of the art. Such techniques are explained fully in the literature.

Prior to describing the various embodiments, the following definitions are provided and should be used unless otherwise indicated.

“Nanostructure” refers to a particle less than 1000 nanometers in all dimensions. The structure may be a nanocrystal. The structure may be heterogenous or homogenous, and can be either mono- or polycrystalline. In some embodiments, the nanostructure is a nanoheterostructure, which includes multiple different components.

“MV²” refers specifically to the methyl viologen cation, but may typically be substituted for other common redox mediators, except where the context indicates otherwise.

“Nanorod” refers to a nanostructure having a specific aspect ratio which agrees with the common understanding of a person skilled in the field of nanotechnology.

“Dot-in-rod” refers to a nanostructure which contains a quantum dot core (a nanoparticle typically less than 10 nm in all dimensions) within a nanorod casing.

Solar-to-Fuel Conversion

Many solar-to-fuel conversion processes, such as hydrogen evolution or carbon dioxide reduction, require the transfer of multiple electrons. Because a single photon absorption event results in the excitation and transfer of one electron in most light harvesting materials, effective schemes for accumulating multiple electrons at the catalyst while simultaneous suppressing charge recombination processes are also required.

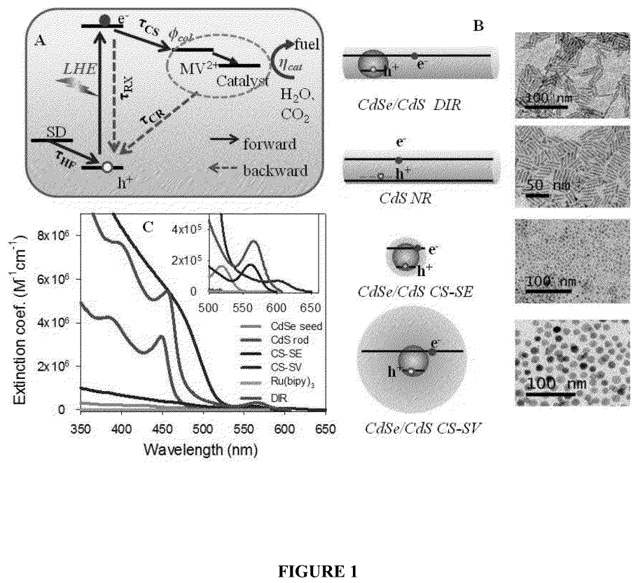

In nature, one-electron redox mediators/relays can be used to sequentially deliver the electrons from the light harvesting units to the catalytic centers. It has been reported that methylviologen^{2+/+} couple (−0.45 vs normal hydrogen electrode) in aqueous solution) can act as an effective one-electron mediator for multi-electron photocatalytic reactions, such as hydrogen evolution (with Pt and hydrogenase), carbon dioxide fixation (with formate dehydrogenase and Pd) and other reductase-dependent reactions (FIG. 1). Although electron transfer from semiconductor nanocrystals to methyl viologen²⁺ has been observed, charge recombination is also rapid in nanocrystal-methyl viologen²⁺ complexes. It is therefore an object of this disclosure to describe an efficient system for photogeneration of MV⁺ radicals and photocatalysis.

In some embodiments, the compositions described herein can be further mixed with a fuel source. The fuel source in certain embodiments is water. In other embodiments, the fuel source is or provides carbon dioxide. In certain embodiments, a method of fuel production is provided including exposing a composition as described herein to a fuel source and a catalyst. In some embodiments, the catalysts is or includes nanoparticles of platinum or palladium. In certain embodiments, the catalyst is or includes an enzyme, such as hydrogenase or formate dehydrogenase. In certain embodiments, the fuel source is water and the catalyst is platinum nanoparticles. In certain embodiments, catalysts are as described in WO/2010/107919.

In some embodiments, the compositions and methods described herein lead to a direct conversion of solar energy to hydrogen with at least 5% or at least 10% or at least 12% or at least about 14% internal quantum efficiency.

Nanoparticles

In certain embodiments, a composition or system is provided that includes a mixture of 3-mercaptopropionic acid (MPA) caped water-soluble CdSe/CdS dot-in-rod (DIR) nanorods, MV²⁺ and excess MPA in aqueous solution. In certain embodiments, the system further includes at least one catalyst nanoparticle. Addition of a catalyst such as a Pd or Pt nanoparticles (NPs) leads to direct conversion of solar energy to H₂ with a ˜14% internal quantum efficiency. Quantum efficiencies and transient kinetics of the CdSe/CdS dot-in-rod nanostructures with a commonly used molecular chromophore, Ru(bipy)3 2+, were compared and nanostructures of different shapes and dimensions were related (FIG. 1B). These compositions include CdSe seed quantum dots (QDs) used to prepared the dot-in-rod nanostructures, CdS rods of similar dimensions (diameter and length), CdSe/CdS core/shell quantum dots of similar lowest exciton energy (CS-SE), and giant CdSe/CdS core/shell quantum dots of similar volume (CS-SV). These comparisons show that the electron and hole wave functions in the CdSe/CdS dot-in-rod nanorods enable ultrafast electron transfer to MV²⁺, ultrafast hole filling by MPA, and ultraslow charge recombination, resulting in the near-unity quantum yield of MV⁺ radical generation. In some embodiments, the nanostructure is not a spherical nanostructure. In some embodiments, the nanostructure includes a rod. In other embodiments, the nanostructure includes a spherical crystal. In some embodiments, the nanostructures are less than 100 nm, and in particular less than 50 nm in length. In some embodiments, the nanostructure is between about 20 and about 50, or between about 30 and about 45 nm in length. In specific embodiments, the nanostructures are less than about 10 nm in diameter, or less than about 8 or less than about 6 or less than about 5 or about between 2 and 4 nm in diameter. In certain other embodiments, the nanostructures are spherical and are less than about 20, or less than about 15, or less than about 10 or less than about 5 nm in diameter. Most typically, the nanostructures are not spherical and are less than about 50 nm in length and less than about 5 nm in diameter.

### EXAMPLES

### Preparation of Semiconducting Nanostructures

CdSe Seed

A mixture of 0.06 g Cadmium Oxide (CdO), 0.28 g Octadecylphosphonic acid (ODPA) and 3 g Trioctylphosphine oxide (TOPO) in a 25 mL flask was heated to 300° C. under Argon flow. After CdO powder were dissolved and the solution became clear, 1.5 g Trioctylphosphine (TOP) was injected. When the temperature reached 350° C., selenium (Se) precursor (0.058 g Se+0.36 g TOP) was swiftly injected and after 5 s, the reaction was stopped by removing the heating mantle. High quality wurtzite CdSe seeds were precipitated by ethanol and re-dissolved in chloroform for further use. The resulting CdSe quantum dots have a lowest exciton peak at 520 nm (corresponding to 2.6 nm core diameter) and the concentration of CdSe was determined from published extinction coefficient.

CdSe/CdS Dot-In-Rod and CdS NRs

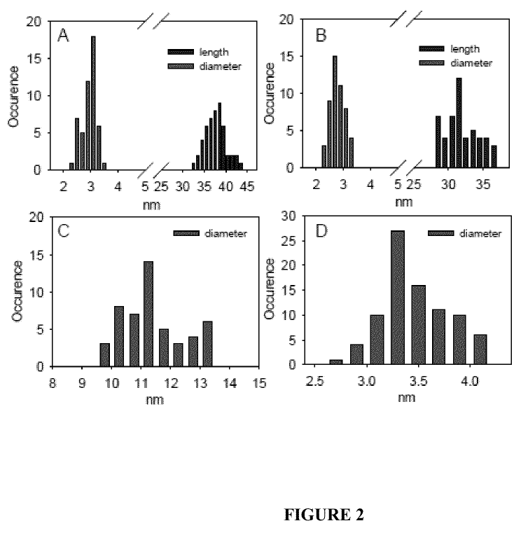

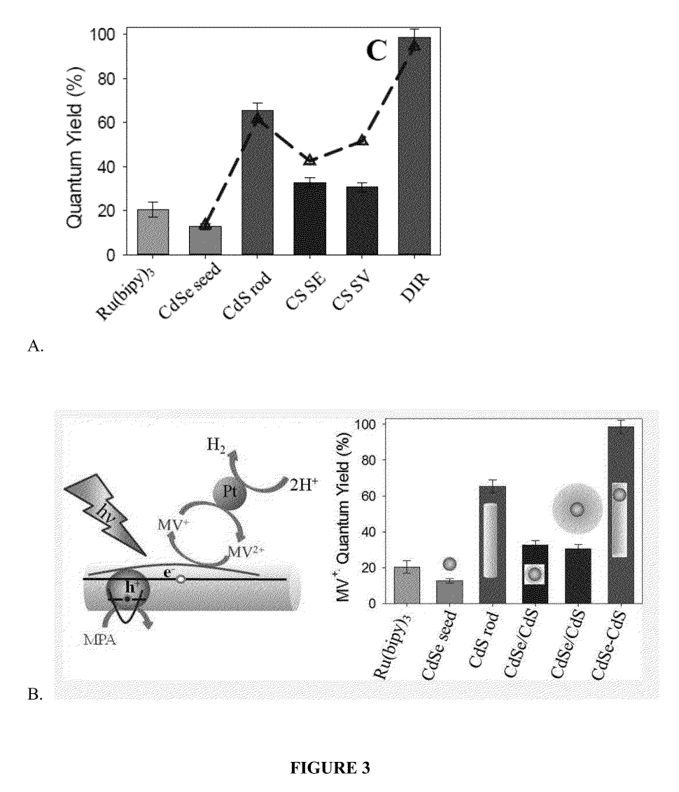

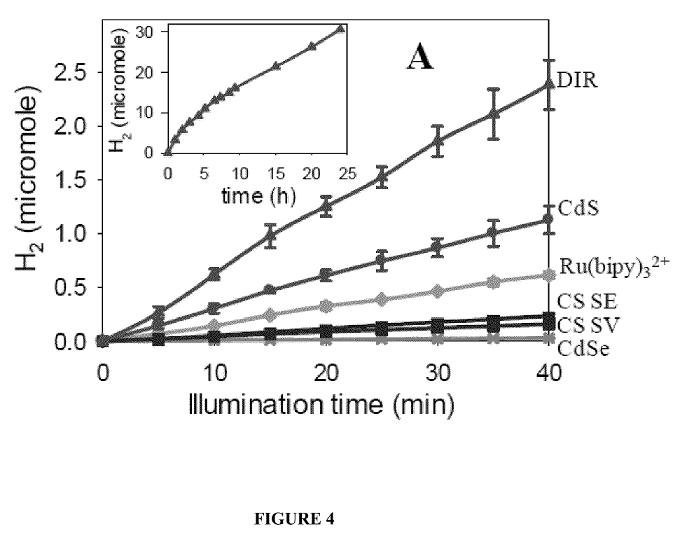

The CdSe/CdS dot-in-rod and CdS nanorods were synthesized following a seeded growth method. The synthesis of CdSe seed was described above. The oleic acid capped wurtzite CdS seeds were synthesized following a literature procedure. To grow the CdS shell, 0.29 g ODPA, 0.08 g hexylphosphonic acid (HPA), 0.06 g CdO and 3 g TOPO were mixed in a 25 mL flask and heated to 300° C. under Argon flow. After CdO powder were fully dissolved and the solution became clear, 1.5 g Trioctylphosphine (TOP) was injected and the temperature was raised to 350° C. CdSe (or CdS) seeds (0.8 μmol) and S precursor (0.12 g S in 1.5 g TOP) were swiftly injected. After 8 minutes, the heating mantle was removed and CdSe/CdS (or CdS) NRs were precipitated with ethanol and redispersed in chloroform for future use. The resulting CdSe/CdS NRs have a lowest exciton peak at 565 nm and an emission spectrum centered at 575 nm. The NRs are 37.3±2.3 nm in length and 3.0±0.2 nm in diameter as shown in FIG. 2. From the TEM image of CdS NRs, we obtained an average length of 31.9±2.4 nm and average diameter of 2.8±0.2 nm.

CdSe/CdS Core/Shell Quantum Dots

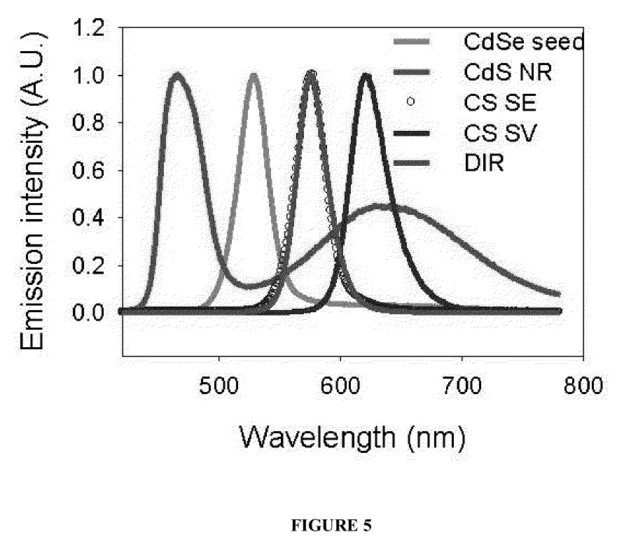

The CdSe/CdS core/shell quantum dots were grown by successive ion layer adsorption and reaction (SILAR) method. A cadmium precursor solution (0.1 M) was prepared by dissolving 0.064 g of CdO in 2.5 mL of oleic acid and 7 mL of 1-octadecene (ODE) at 300° C. to obtain a colorless solution. The precursor solution was then maintained at above 100° C. A sulfur injection solution (0.1 M) was prepared by dissolving 32 mg of sulfur in 10 mL of ODE in an ultrasonic bath. The CdS shells were grown one layer at a time, by the successive injection of calculated amounts of cadmium and sulfur solutions using air-free syringe pump with a rate of 1 mL/h). The CdSe/CdS core/shell quantum dots of similar energy (CS-SE) was prepared by monitor emission peak evolution until it agrees with that of CdSe/CdS dot-in-rod nanostructure, as shown in FIG. 5. The TEM images of CdSe/CdS CS-SE quantum dots showed a diameter of 3.4±0.3 nm. To grow giant CdSe/CdS core/shell quantum dots of similar volume (CS-SV) as dot-in-rod nanostructures, the amount of Cd and S precursors required was estimated from the desired CdS shell volume. The shell growth was performed initially at 180° C. to maintain the core size and gradually increased up to 240° C. The time interval between two successive injections was 20 minutes. After purification and precipitation, CdSe/CdS quantum dots were re-dissolved in chloroform for further measurements. The TEM image of the gaint CdSe/CdS quantum dots are shown FIG. 2, from which we obtained a diameter of 11.4±0.4 nm. The volume of these quantum dots is ˜2 times bigger than CdSe/CdS dot-in-rod nanoheterostructure.

Ligand Exchange to Make Water Soluble Nanostructures.

The nanostructures prepared above were transformed into water by ligand exchange with 3-mercaptopropionic acid (MPA). Excess amount of MPA (20 μL) was dissolved in 10 mL methanol and the pH of the solution was adjusted to above 10 with tetramethylammonium hydroxide. A few mg of nanostructures were added and the solution was refluxed at 70° C. overnight with N₂ in dark. The MPA capped nanostructures were precipitated with ethyl acetate and isolated by centrifugation and decantation. After drying, the precipitate was redissolved in water for further use.

### Photoreduction of Methyl Viologen²⁺

Sample preparation. The samples for NC-MV²⁺ charge recombination study were prepared by adding a drop of high concentrated MV²⁺ methanol solution into a NC chloroform solution followed by sonication. After filtration to remove excess amount of unabsorbed MV²⁺, the transparent samples were used for transient absorption measurement. The aqueous samples for NC-MV²⁺ with MPA used for charge separation and transient quantum yield measurement were prepared in the same way as those for steady state MV²⁺ photoreduction experiment except for the four times lower NC concentrations.

MV²⁺ Photoreduction Measurement.

Light-driven MV²⁺ reduction was performed in a standard threaded-top fluorescence cuvette (Spectrocell, RF-3010-T) with a total volume of ˜3 ml and a path-length of 1 cm. The cuvette was filled with 2.0 ml reaction solutions of sensitizers (concentration to be specified below), MV²⁺ (5.0 mM), sacrificial electron donor (50 mM) (MPA for NCs and Triethanolamine (TEOA) for Ru(bipy)₃²⁺; both neutralized to 7 with HCl or NaOH before mixing) and buffer (50 mM phosphate, pH 7.8). In order to ensure same photon absorption rate, the concentrations of sensitizers were adjusted to have the same absorbance at the illumination wavelength (Abs=1.1 at 455 nm). Based on the estimated extinction coefficients shown in FIG. 1 of the main text, the actual sensitizer concentration was ˜10 μM for CdSe seed, ˜0.43 μM for CdS nanorods, ˜3 μM for CdSe/CdS CS-SE, ˜0.2 μM for CdSe/CdS CS-SV, ˜100 μM for Ru(bipy)₃²⁺, ˜0.2 μM for CdSe/CdS dot-in-rod nanostructures. The reaction cell was sealed with a rubber septum, degassed and filled with Argon. The removal of oxygen was confirmed with HP5890A model gas chromatograph equipped with a thermal conductivity detector and a HP-MOLESIEVE capillary GC column (30 m×0.535 mm×25.00 μm) packed with 5 Å molecular sieves. The integrity of the seal was tested by monitoring the absorption spectra reduced MV in dark, which shows slightly (˜5%) decrease after 1 h. All procedures were performed with a minimum exposure to ambient light.

Quantum Yield for MV⁺ Generation

Before illumination, the UV-Vis absorption spectrum of the solution was taken as zero time. The reaction was initiated by unblocking the stabilized LED-light source (λ=455 nm; light intensity 2.4 mW, beam diameter ˜0.4 cm) with constant stirring of the solution (by a magnetic stirrer). The UV-Vis absorption spectra of the solution were taken after a certain time of illumination (seconds), interrupting the illumination by less than 20 s for each spectrum recording. Error bars on MV concentrations were calculated from at least two independent experiments. The MV generation quantum yield for these sensitizers is defined as ΦMV=Δ(MV⁺)/Δ(v) where Δ(MV⁺) is the MV⁺ generation rates and Δ(v) is the photon absorption rates by the reaction solution, respectively. MV generation rates Δ(MV⁺) were obtained from the slope of the initial three pointes including 0, 2 s and 5 s. The photon absorption rate Δ(v) was calculated from the illumination power and the absorbance of the reaction solution. The illumination power, 2.4 mW, was measured at the front of the reaction cell using a digital laser power meter (OPHIR, model NOVA II). The amount of absorbed light can be determined from sample absorbance (Abs=1.10 at 455 nm) and the measured power after correcting the loss by the cuvette front window. The loss of an empty cell was determined to be 14% by UV/Vis spectrometer, from which we assume a 7% loss for each window. The absorbed light intensity is 2.4*0.93*(1-10-1.1) mW.

### H₂ Evolution Using Platinum as a Catalyst (Solar to Fuel Conversion)

PVA-Pt Synthesis:

Pt particles used as the catalyst for hydrogen evolution were synthesized by thermal reduction of H₂PtCl₆ with citrate. After refluxing the solution for 4 h, excess citrate was removed by Amberlite-MB-1 exchange in an ice bath. After filtration, Polyvinyl alcohol (PVA, mass ratio PVA/Pt=1/1) was added as protective agent and the solution was stirred overnight. The concentration of Pt in reaction solution for H₂ evolution was estimated to be ˜0.8 mM based on reported extinction coefficient.

H₂ Generation Measurement.

The H₂ generation reaction was performed in a cylindrical cuvette (NSG, 32UV10) with a total volume of ˜2.5 ml following the same operation procedures as the MV²⁺ reduction experiment described above. The reaction volume (2.0 ml) and the concentrations of MV²⁺, nanostructures and MPA remain unchanged. A different buffer (50 mM phosphate, pH 6.2) and a higher light intensity (8.0 mW) were used and PVA-Pt (0.8 mM) were added as the H₂ evolution catalysts Analysis of H₂ in the reaction headspace was performed using a HP5890A model gas chromatograph equipped with a thermal conductivity detector and a HP-MOLESIEVE capillary GC column (30 m×0.535 mm×25.00 μm) packed with 5 Å molecular sieves. Argon was used as a carrier gas. Typically, the H₂ amount was quantified by withdrawing a gas sample from the headspace without stopping the reaction. Error bars on H₂ were calculated from at least two independent experiments.

Quantum Yield for H₂ Generation

is defined as ΦMV=2Δ(H₂)/Δ(v) where Δ(H₂) is the H₂ generation rates. For external quantum yield, Δ(v) is the incident light intensity (8.0 mW) which was measured at the front of the reaction cell using a digital laser power meter (OPHIR, model NOVA II). To estimate the internal quantum yield, the photon loss has to be corrected. The loss comes from three processes: 1) scattering and reflection of cuvette front window (˜9% loss), 2) scattering of suspended nanostructures in water, and 3) absorption by PVA-Pt catalyst. The absorbance of PVA-Pt and NCs at 455 nm are 0.8 and 1.1, respectively, from which the light intensity absorbed by sensitizer was estimated to be 8.0*0.91*1.1/(1.1+0.8) mW. Because the scattering loss of the suspension is not taken into account, the estimated internal quantum yield should be taken as the lower limit.

It is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

1) A composition comprising a redox mediator, an electron donor, and a semiconducting nanostructure photosensitizer comprising:
b) a core nanocrystal including a first semiconductor material; and
c) an overcoating including a second semiconductor material on the core nanocrystal.

2) The composition of claim 1 wherein the nanostructure forms a dot-in-rod configuration.

3) The composition of claim 1 wherein the first semiconductor material comprises CdSe.

4) The composition of claim 1 wherein the second semiconductor material comprises CdS.

5) The composition of claim 1 wherein:
a) the first semiconductor material comprises CdSe and the second semiconductor material comprises CdS; and
b) the redox mediator is methyl viologen; and
c) the electron donor is mercaptoproprionic acid.

6) The composition of claim 1 suspended as a colloid.

7) A method for photoreduction of a redox mediator, comprising:
a) providing a composition comprising a redox mediator, an electron donor, and a semiconducting nanostructure photosensitizer comprising: a core nanocrystal including a first semiconductor material; and an overcoating including a second semiconductor material on the core nanocrystal; and
b) exposing the composition to light.

8) The method of claim 7 wherein the nanostructure forms a dot-in-rod configuration.

9) The method of claim 7 wherein the method further includes, prior to exposing the composition to light, mixing the composition with a fuel source and a catalyst.

10) The method of claim 8, where the fuel source is water or carbon dioxide.

11) The method of claim 8, where the catalyst is nanoparticles of platinum or palladium.

12) The method of claim 8, where the catalyst is an enzyme, such as hydrogenase or formate dehydrogenase.

13) The method of claim 8, where the fuel source is water and the catalyst is platinum nanoparticles.
